(19) United States
(12) Patent Application Publication
(10) Pub. No.: US 2025/0021123 A1
(43) Pub. Date: Jan. 16, 2025

(54) BANDGAP REFERENCE (BGR) CIRCUIT FOR GENERATING BGR VOLTAGE AND A METHOD THEREOF

(71) Applicant: INDIAN INSTITUTE OF TECHNOLOGY ROPAR, Rupnagar (IN)

(72) Inventors: Mahendra SAKARE, Rupnagar (IN); Mayank Kumar SINGH, Rupnagar (IN); Rajasekhar NAGULAPALLI, Oxford (GB)

(73) Assignee: INDIAN INSTITUTE OF TECHNOLOGY ROPAR, Rupnagar (IN)

(21) Appl. No.: 18/373,713

(22) Filed: Sep. 27, 2023

(30) Foreign Application Priority Data
Jul. 12, 2023 (IN) 202311046972

(51) Int. Cl. G05F 3/26

(52) U.S. Cl. CPC G05F 3/267

(57) ABSTRACT

Present disclosure relates to BGR circuit (100) and method (500) for generating BGR voltage. BGR circuit (100) comprises bandgap reference core circuit (102) and complementary-to-absolute-temperature (CTAT) generation circuit (104). Base of transistor (Q1) connected to ground and base of transistor (Q2) connected to V_{X}. CTAT generation circuit (104) comprises second current mirror, third current mirror, third transistor (Q3), load resistor (RL), second resistor (R2) and third resistor (R3). Base of transistor Q2 connected to one end of resistor (R2) and one end of resistor (R3). Other end of resistor (R3) is connected to ground. Other end of second resistor (R2) is connected to emitter of transistor (Q3) and drain of third MOSFET (M3). Output of amplifier coupled to first current mirror and second current mirror. Second resistor (R2) connected to drain of M3 and CTAT generation circuit (104) has output node for outputting BGR voltage.

### CROSS-REFERENCE TO RELATED APPLICATIONS AND PRIORITY

The present application claims benefit from Indian patent application No. 202311046972 filed on 12 Jul. 2023 the entirety of which is hereby incorporated by reference.

### TECHNICAL FIELD

The present disclosure, in general, relates to a field of electronics and communication engineering. More particularly, the present disclosure relates to bandgap reference (BGR) circuit for generating bandgap reference (BGR) voltage.

### BACKGROUND

Bandgap Reference (BGR) is an important module of modern analog integrated circuits and digital-analog hybrid integrated circuits. The BGR circuit is generally used in integrated circuits to provide a stable voltage reference independent of process, voltage, and temperature variations. The BGR circuit is used in analog circuits such as amplifiers, oscillators, and voltage regulators.

The BGR circuit generally includes a differential amplifier, a diode-connected bipolar transistor, and a current source. The differential amplifier compares output voltage of diode-connected transistor with a voltage reference and adjusts the current flowing through the transistor until the two voltages are equal. The results in a stable output voltage are independent of temperature variations. The BGR circuit is designed using two circuits. The two circuits are proportional to absolute temperature (PTAT) voltage and complementary to absolute temperature (CTAT) voltage. The BGR circuit design scaling the PTAT and CTAT to obtain a temperature independent of the reference voltage. The PTAT circuit includes a diode, a resistor, and an amplifier. The amplifier amplifies the voltage across the resistor, which is proportional to the diode temperature and compensates for any non-linearities in the circuit. In the place of diodes, bipolar junction transistors are also be used. The output voltage is proportional to the absolute temperature T, which means that the voltage change due to temperature is constant over a wide range of temperatures. The CTAT refers to a circuit or device that generates an output voltage complementary to the device's or circuit's absolute temperature. In other words, the output voltage of the CTAT circuit varies inversely with temperature. The bandgap reference is designed by compensating for the CTAT and PTAT behaviour.

In existing art, BGR circuits are designed by combining PTAT and CTAT voltages in a weighted sum. However, as technology evolved and supply voltages decreased, temperature coefficient cancellation is achieved in the current domain instead. Some conventional BGR circuits may not provide a fast-enough startup. Additionally, the conventional BGR circuits are overly complicated and power consuming, and do not do well with low supply voltages.

### SUMMARY

Before the present receiver bandgap reference (BGR) circuit and method for generating bandgap reference (BGR) voltage is described, it is to be understood that this application is not limited to the particular process, and methodologies described, as there can be multiple possible embodiments that are not expressly illustrated in the present disclosure. It is also to be understood that the terminology used in the description is to describe the particular versions or embodiments only, and is not intended to limit the scope of the present application. This summary is not intended to identify essential features of the claimed subject matter nor is it intended for use in determining or limiting the scope of the claimed subject matter.

In one implementation, a bandgap reference (BGR) circuit for generating bandgap reference (BGR) voltage is described. The BGR circuit comprises a bandgap reference core circuit and a complementary-to-absolute-temperature (CTAT) generation circuit. The bandgap reference core circuit is a proportional-to-absolute-temperature (PTAT) generation circuit and the PTAT generation circuit comprises an operational amplifier, transistors and a first current mirror. The transistors comprise a first transistor (Q1) and a second transistor (Q2) and the transistors are serially connected across a first input of the amplifier and a second input of the amplifier. The base of the first transistor (Q1) is connected to ground and base of the second transistor (Q2) is connected to V_{X}. The first current mirror comprising a first MOSFET (M1) and a second MOSFET (M2). The CTAT generation circuit comprises a second current mirror, a third current mirror, a third transistor (Q3), a load resistor (RL), a second resistor (R2) and a third resistor (R3). Base of the second bipolar junction transistor (Q2) connected to one end of the second resistor (R2) and one end of the third resistor (R3), and wherein other end of third resistor (R3) is connected to the ground and wherein other end of the second resistor (R2) is connected to emitter of the third bipolar junction transistor (Q3) and drain of the third MOSFET (M3). An output of the operational amplifier is coupled to the first current mirror and the second current mirror. The second resistor (R2) is connected to drain of the third MOSFET (M3) and thus creating the third current mirror in the BGR, and the CTAT generation circuit has an output node for outputting a bandgap reference voltage.

In another implementation, method for non-coherent distributed transmission (NCDT) is described. The method comprises of configuring the bandgap reference core circuit and the CTAT generation circuit. The bandgap reference core circuit is th PTAT generation circuit and the PTAT generation circuit comprises an operational amplifier, transistors and the first current mirror. The transistors comprise the first transistor (Q1) and the second transistor (Q2) and the transistors are serially connected across a first input of the amplifier and a second input of the amplifier. The base of the first transistor (Q1) is connected to ground and base of the second transistor (Q2) is connected to V_{X}. The first current mirror comprising a first MOSFET (M1) and a second MOSFET (M2). The CTAT generation circuit comprises the second current mirror, the third current mirror, the third transistor (Q3), the load resistor (RL), the second resistor (R2) and the third resistor (R3). Base of the second bipolar junction transistor (Q2) connected to one end of the second resistor (R2) and one end of the third resistor (R3), and wherein other end of third resistor (R3) is connected to the ground and wherein other end of the second resistor (R2) is connected to emitter of the third bipolar junction transistor (Q3) and drain of the third MOSFET (M3). An output of the operational amplifier is coupled to the first current mirror and the second current mirror. The second resistor (R2) is connected to drain of the third MOSFET (M3) and thus creating the third current mirror in the BGR, and the CTAT generation circuit has an output node for outputting a bandgap reference voltage.

### BRIEF DESCRIPTION OF DRAWINGS

The detailed description is described with reference to the accompanying figures. In the figures, the left-most digit(s) of a reference number identifies the figure in which the reference number first appears. The same numbers are used throughout the drawings to refer like features and components.

FIG. 1 illustrates a conventional current-mode bandgap reference (BGR) circuit, in accordance with an embodiment of the present subject matter;

FIG. 2 illustrates a block diagram of bandgap reference (BGR) circuit (100) for generating BGR voltage, in accordance with an embodiment of the present subject matter;

FIG. 3 illustrates a plot showing reference voltage generated by the BGR circuit (100) with respect to change in supply voltage, in accordance with an embodiment of the present subject matter;

FIG. 4 illustrates a plot showing reference voltage generated by the BGR circuit (100) with respect to temperature change, in accordance with an embodiment of the present subject matter; and

FIG. 5 illustrates a flow diagram of a method for generating bandgap reference (BGR) voltage T, in accordance with an embodiment of the present subject matter; and

### DETAILED DESCRIPTION

Some embodiments of the present disclosure, illustrating all its features, will now be discussed in detail. The words “comprising”, “receiving”, “determining”, “assigning” and other forms thereof, are intended to be equivalent in meaning and be open ended in that an item or items following any one of these words is not meant to be an exhaustive listing of such item or items or meant to be limited to only the listed item or items. It must also be noted that as used herein and in the appended claims, the singular forms “a”, “an” and “the” include plural references unless the context clearly dictates otherwise. Although any system and methods similar or equivalent to those described herein can be used in the practice or testing of embodiments of the present disclosure, the exemplary, bandgap reference (BGR) circuit and method for generating bandgap reference (BGR) voltage are now described. The disclosed embodiments of the BGR circuit and method for generating the BGR voltage are merely exemplary of the disclosure, which may be embodied in various forms.

Various modifications to the embodiment will be readily apparent to those skilled in the art and the generic principles herein may be applied to other embodiments. However, one of ordinary skill in the art will readily recognize that the present disclosure for bandgap reference (BGR) circuit for generating bandgap reference (BGR) voltage is not intended to be limited to the embodiments illustrated but is to be accorded the widest scope consistent with the principles and features described herein.

Conventional bandgap references are designed by combining PTAT and CTAT voltages in a weighted sum. However, as technology evolved and supply voltages decreased, temperature coefficient cancellation has been achieved in the current domain instead. One way to accomplish this problem is by taking advantage of the PTAT behavior exhibited by the difference in base-emitter voltages of two diodes biased at different current densities and the CTAT behavior of the base-emitter voltage (VBE) of bipolar junction transistors (BJT) itself.

The present subject matter overcome the problems of the existing system and provides a BGR circuit and method for generating BGR voltage. The Bandgap Reference (BGR) is essential to most analog circuits, providing a temperature-independent voltage reference and may crucial for circuits like oscillators, amplifiers, and regulators, which require a PTAT current reference to ensure stable performance under temperature variations. The original BGR design based on BJTs generates a PTAT and a CTAT voltage, which are scaled and combined to create a temperature-independent reference voltage of 1.2 V, close to the bandgap energy of silicon.

A voltage mode bandgap reference as per the present embodiment is based on the exponential properties of the BJT devices is proposed to generate a PTAT and CTAT voltage, scale and sum them to obtain a temperature-independent reference voltage and the circuit can be adjusted to any desired value and provides PTAT voltage. The additional BJT and resistance provide an extra parameter to accurately adjust the reference voltage.

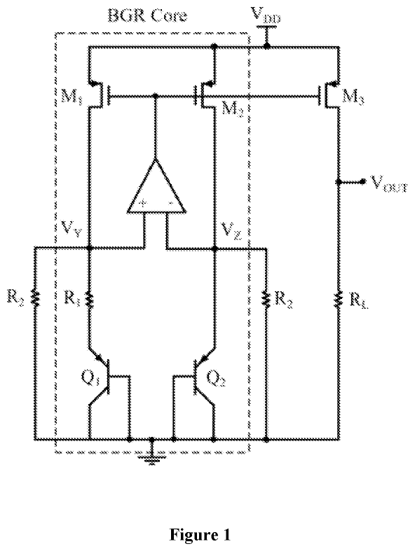

Referring now to the drawings, and more particularly to FIGS. 1 through 5, where similar reference characters denote corresponding features consistently throughout the figures, there are shown embodiments.

Referring now to FIG. 1, current-mode bandgap reference (BGR) circuit is described. FIG. 1 illustrates a current mode bandgap, where the opamp virtual node generates a CTAT voltage, resulting in a CTAT current in R₂. The BJT Q2 is m times larger than Q1. The current in R1 exhibits PTAT behavior, and the currents in M1 and M2 are adjusted slightly to compensate for the temperature coefficient of the resistor. The currents through R1 and R2 are given as,

$${I}_{R 1} = \frac{{V}_{T}}{{R}_{1}} ln ( N \frac{( 1 + β 2 ) β 1}{( 1 + β 1 ) β 2} ) \qquad ( 1 )$$

$${I}_{R 2} = \frac{{V}_{BE 1}}{{R}_{2}} \qquad ( 2 )$$

V_{T} represents the thermal voltage in the equation. The reference voltage VBG in a bandgap circuit is generated by summing the currents I_{R1} and I_{R2}, which are proportional to the PTAT and CTAT voltages. The value of V_{REF} is obtained by passing this sum through RL. The diodes used in the circuit have a ratio of N, and their forward current gains are denoted by β1 and β2.

$${V}_{REF} = \frac{{R}_{1}}{{R}_{2}} ( {V}_{BE 1} + \frac{{R}_{2}}{{R}_{1}} {V}_{T} ln ( N \frac{( 1 + β 2 ) β 1}{( 1 + β 1 ) β 2} ) ) \qquad ( 3 )$$

The output voltage may be adjusted by R₃ to any desired value, which is a major advantage over the traditional bandgap. While the sub-1 V current mode bandgap has the advantage of output voltage adjustability, it also has several disadvantages. The BJT's Q₁ and Q₂ are shunted by R₂, leading to multiple stable operating points, which is a significant drawback. This increases the risk of failure during mass production and poses a challenge to the design of the start-up circuit. Extensive start-up simulations are often conducted over various process, voltage, and temperature (PVT) corners and Monte Carlo simulations to ensure proper operation. Moreover, R₂ usually has a high value, typically in the range of 500 kΩ, which significantly impacts the overall area of the circuit.

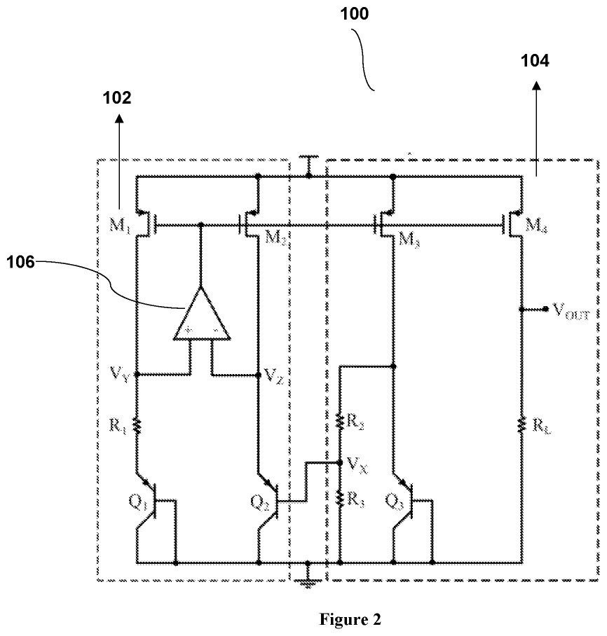

In accordance with an embodiment, referring now to FIG. 2, a block diagram of the bandgap reference (BGR) circuit 100 for generating BGR voltage is described. The BGR circuit comprises a bandgap reference core circuit 102 and a complementary-to-absolute-temperature (CTAT) generation circuit 104.

The bandgap reference core circuit 102 is a proportional-to-absolute-temperature (PTAT) generation circuit. The PTAT generation circuit comprises an operational amplifier (opamp) (alternatively may referred as amplifier), transistors and a first current mirror. In an example, the transistors comprise two or more transistors. As shown in FIG. 2, the transistors comprise a first transistor (Q1) and a second transistor (Q2). The transistors are serially connected across a first input of the amplifier and a second input of the operational amplifier and wherein base of the first transistor (Q1) is connected to ground and base of the second transistor (Q2) is connected to V_{X}. The first current mirror comprising a first MOSFET (M1) and a second MOSFET (M2). The transistors of the PTAT generation circuit (Q1 and Q2) comprises bipolar junction transistors (BJT) and the BJT has a base and base of the second transistor (Q2) is connected to V_{X}.

The CTAT generation circuit 104 comprises a second current mirror, a third current mirror, a third transistor (Q3), a load resistor (RL), a second resistor (R2) and a third resistor (R3). The second current mirror comprises a third MOSFET (M3) and the third current mirror comprising a fourth MOSFET (M4). As shown in FIG. 2, base of the second bipolar junction transistor (Q2) is connected to one end of the second resistor (R2) and one end of the third resistor (R3), and other end of third resistor (R3) is connected to the ground. The other end of the second resistor (R2) is connected to emitter of the third bipolar junction transistor (Q3) and drain of the third MOSFET (M3). An output of the operational amplifier is coupled to the first current mirror and the second current mirror. The second resistor (R2) is connected to drain of the third MOSFET (M3) and thus creating the third current mirror in the BGR. The CTAT generation circuit 104 has an output node for outputting the bandgap reference (BGR) voltage. The transistor of the CTAT generation circuit (Q3) comprises a bipolar junction transistor (“BJT”). The bandgap reference voltage depends on the resistances of the first resistor (R1), the second resistor (R2), the third resistor (R3), and the load resistor (RL).

In an exemplary embodiment, by assuming the current I_{B2} (base current of the second BJT) is zero and V_{X} is the node voltage at the base of Q2. Now, applying the voltage divider around the Q3 and V_{X},

$${v}_{x} = - {v}_{BE 3} ( \frac{{R}_{3}}{{R}_{3} + {R}_{2}} ) \qquad ( 4 )$$

Assuming the V_{Y} is node voltage at the emitter of Q2. Due to the negative feedback of the operational amplifier, the V_{Y} may appear at the inverting terminal of the operational amplifier. Applying Kirchhoffs Voltage Law (KVL) from V_{X} to V_{Y},

$${V}_{Y} = {V}_{x} - {V}_{BE 2} \qquad ( 5 )$$

The current flowing through R_{L} is given by,

$${I}_{0} = \frac{{v}_{Y} + {v}_{BE}^{1}}{{R}_{1}} = \frac{{v}_{X} - {V}_{BE 2} + {V}_{BE 1}}{{R}_{1}} \qquad ( 6 )$$

The base-emitter voltage of BJT Q1, and Q2 is given by,

$${v}_{BE 1} = {v}_{T} ln ( \frac{{I}_{0}}{{nI}_{\dot{s}}} ) \qquad ( 7 )$$

$${v}_{BE 2} = {v}_{T} ln ( \frac{{I}_{0}}{{mI}_{\dot{s}}} ) \qquad ( 8 )$$

The reference voltage of the proposed voltage mode BGR is given by

$${V}_{BG} = {I}_{0} {R}_{L} \qquad ( 9 )$$

$${v}_{REF} = {R}_{L} ( \frac{Vx - VBE 2 + VBE 1}{{R}_{1}} ) \qquad ( 10 )$$

$${v}_{REF} = \frac{{R}_{L}}{{R}_{1}} ( {v}_{T}^{l n} ( \frac{m}{n} ) - {v}_{BE 3} ( \frac{{R}_{3}}{{R}_{3} + {R}_{2}} ) ) \qquad ( 11 )$$

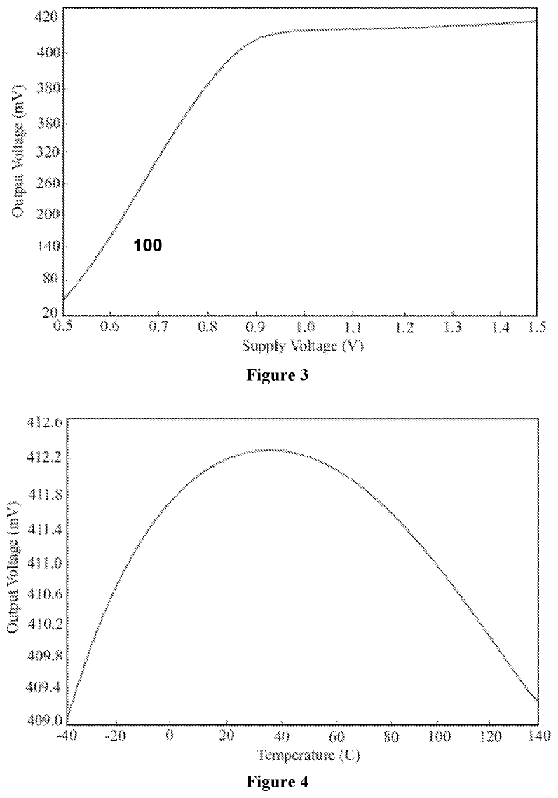

As analysed above, the BGR circuit 100 has a reference voltage (BGR voltage) that depends on the resistances R₁, R₂, R₃, and R_{L}. The conventional BGR circuit has a reference voltage that depends only on R₁, R₂, and R_{L}. The additional dependence on R₃ in the BGR circuit 100 allows for greater control over the output voltage and may improve accuracy compared to traditional BGRs. The simulation results of the proposed voltage mode BGR circuit are presented in FIG. 3 and FIG. 4.

Referring now to FIG. 3, a plot is showing reference voltage generated by the BGR circuit (100) with respect to change in supply voltage. In an exemplary embodiment, FIG. 3 depicts the effect of the change in supply voltage, ranging from 0.5 V to 1.5 V, on the reference voltage, which shows a minimal variation of only 2 mV. T. The reference voltage is approximately 200 mV, which the value of RL can adjust.

In accordance with an embodiment, referring to FIG. 4, a plot is showing reference voltage generated by the BGR circuit (100) with respect to temperature change. FIG. 4 illustrates the change in reference voltage due to the temperature variation in the range of −40° C. to 140° C. The results indicate a negligible variation of only 1 mV, demonstrating the stability of the proposed voltage mode BGR over a wide temperature range.

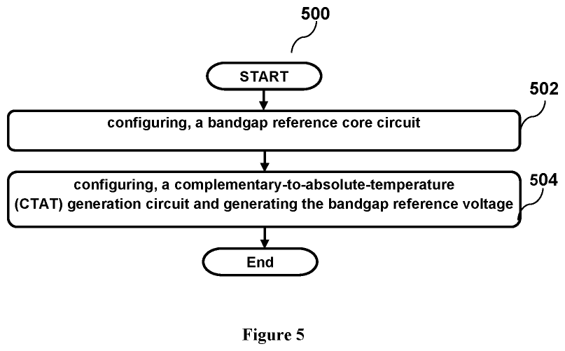

Referring now to FIG. 5, a flow diagram of a method 500 for generating the BGR voltage is described.

As part of the method 500, at step 502, the method 500 includes configuring, a bandgap reference core circuit 102 and the bandgap reference core circuit 102 is the proportional-to-absolute-temperature (PTAT) generation circuit.

As part of the method 500, at step 504, the method 500 includes configuring, the CTAT generation circuit 104 and generating the bandgap reference voltage. The base of the second bipolar junction transistor (Q2) connected to one end of the second resistor (R2) and one end of the third resistor (R3), and the other end of third resistor (R3) is connected to the ground. The other end of the second resistor (R2) is connected to emitter of the third bipolar junction transistor (Q3) and the drain of the third MOSFET (M3). The output of the amplifier is coupled to the first current mirror and the second current mirror, and the second resistor (R2) is connected to drain of the third MOSFET (M3) and thus creating the third current mirror in the BGR. The CTAT generation circuit 104 has the output node for outputting the bandgap reference voltage.

The order in which the method 500 is described is not intended to be construed as a limitation, and any number of the described method blocks can be combined in any order to implement the method 500 or alternate methods. Additionally, individual blocks may be deleted from the method 500 without departing from the scope of the subject matter described herein.

Exemplary embodiments discussed above may provide certain advantages. Though not required to practice aspects of the disclosure, the advantages may include those provided by the following features.

The proposed method 500 and the circuit 100 provides voltage mode bandgap reference (BGR) circuit for sub-1V supply voltage. The voltage mode bandgap reference based on the exponential properties of BJT devices is proposed to generate a PTAT and CTAT voltage, scale, and sum them to obtain a temperature and supply-independent reference voltage. The reference voltage can be adjusted to any desired value under sub-1V based on the resistance values.

In the proposed method 500 and the circuit 100 may overcome the problem of the current mode BGR such as multiple stable operating points and mass production issues due to a larger area (because of large shunting resistances).

Various other modifications, adaptations, and alternative designs are of course possible in light of the above teachings. Therefore, it should be understood at this time that, within the scope of the appended claims, the invention can be practiced otherwise than as specifically described herein.

1. A bandgap reference (BGR) circuit (100) for generating bandgap reference (BGR) voltage, comprising:
a bandgap reference core circuit (102), wherein bandgap reference core circuit (102) is a proportional-to-absolute-temperature (PTAT) generation circuit, wherein the PTAT generation circuit comprises:
an operational amplifier (106);
transistors, wherein the transistors comprise a first transistor (Q1) and a second transistor (Q2), wherein the transistors are serially connected across a first input of the amplifier and a second input of the operational amplifier and wherein base of the first transistor (Q1) is connected to ground and base of the second transistor (Q2) is connected to V_{X}, and
a first current mirror, wherein the first current mirror comprising a first MOSFET (M1) and a second MOSFET (M2);
a complementary-to-absolute-temperature (CTAT) generation circuit (104) comprises:
a second current mirror, wherein the second current mirror comprising a third MOSFET (M3); and
a third current mirror comprising a fourth MOSFET (M4);
a third transistor (Q3);
a load resistor (RL); and
a second resistor (R2) and a third resistor (R3), wherein base of the second bipolar junction transistor (Q2) connected to one end of the second resistor (R2) and one end of the third resistor (R3), and wherein other end of third resistor (R3) is connected to the ground and wherein other end of the second resistor (R2) is connected to emitter of the third bipolar junction transistor (Q3) and drain of the third MOSFET (M3),
and wherein an output of the operational amplifier is coupled to the first current mirror and the second current mirror,
wherein the second resistor (R2) is connected to drain of the third MOSFET (M3) and thus creating the third current mirror in the BGR, and
wherein the CTAT generation circuit (104) has an output node for outputting a bandgap reference voltage.

2. The BGR circuit as claimed in claim 1, wherein the transistors (Q1 and Q2) of the PTAT generation circuit (102) comprises bipolar junction transistors (BJT), wherein the BJT has a base and base of the second transistor (Q2) is connected to V_{X}.

3. The BGR circuit as claimed in claim 1, wherein transistor of the CTAT generation circuit (104) comprises a bipolar junction transistor (BJT).

4. The BGR circuit as claimed in claim 1, wherein the bandgap reference voltage depends on the resistances of the first resistor (R1), the second resistor (R2), the third resistor (R3), and the load resistor (RL).

5. The BGR circuit as claimed in claim 1, wherein the BGR circuit generates a PTAT voltage and a CTAT voltage, scale the voltage, and sum PTAT voltage and a CTAT voltage to obtain a temperature-independent reference voltage.

6. A method for generating bandgap reference (BGR) voltage, the method comprising:
configuring, a bandgap reference core circuit (102), wherein bandgap reference core circuit (102) is a proportional-to-absolute-temperature (PTAT) generation circuit, wherein the PTAT generation circuit comprises:
an operational amplifier;
transistors, wherein the transistors comprise a first transistor (Q1) and a second transistor (Q2), wherein transistors are serially connected across a first input of the amplifier and a second input of the amplifier and wherein base of the first transistor (Q1) is connected to ground and base of the second transistor (Q2) is connected to V_{X}; and
a first current mirror, wherein the first current mirror comprising a first MOSFET (M1) and a second MOSFET (M2);
configuring, a complementary-to-absolute-temperature (CTAT) generation circuit (104) and generating a bandgap reference voltage, wherein the CTAT generation circuit (104) comprises:
a second current mirror, wherein the second current mirror comprising a third MOSFET (M3); and
a third current mirror comprising a fourth MOSFET (M4);
a third transistor (Q3);
a load resistor (RL); and
a second resistor (R2) and a third resistor (R3), wherein base of the second bipolar junction transistor (Q2) connected to one end of the second resistor (R2) and one end of the third resistor (R3), and wherein other end of third resistor (R3) is connected to the ground and wherein other end of the second resistor (R2) is connected to emitter of the third bipolar junction transistor (Q3) and drain of the third MOSFET (M3),
and wherein an output of the amplifier is coupled to the first current mirror and the second current mirror,
wherein second resistor (R2) is connected to drain of the third MOSFET (M3) and thus creating the third current mirror in the BGR, and
wherein the CTAT generation circuit (104) has an output node for outputting the bandgap reference voltage.

7. The method as claimed in claim 6, wherein the transistors of the PTAT generation circuit comprises bipolar junction transistors (BJT), wherein the BJT has a base and base of the second transistor (Q2) is connected to V_{X}.

8. The method as claimed in claim 6, wherein transistor of the CTAT generation circuit (104) comprises a bipolar junction transistor (BJT).

9. The method as claimed in claim 6, wherein the bandgap reference voltage depends on the resistances of the first resistor (R1), the second resistor (R2), the third resistor (R3), and the load resistor (RL).

10. The method as claimed in claim 6, wherein the BGR circuit generates a PTAT voltage and a CTAT voltage, scale the voltage, and sum PTAT voltage and a CTAT voltage to obtain a temperature-independent reference voltage.
